(19) United States
(12) Patent Application Publication
(10) Pub. No.: US 2025/0043915 A1
(43) Pub. Date: Feb. 6, 2025

(54) SYSTEM FOR FILLING A CRYOGENIC CONTAINER ON A VEHICLE IN AN ENVIRONMENTALLY FRIENDLY WAY

(71) Applicants: CRYOSHELTER LH2 GMBH, Dobl-Zwaring (AT); CRYOSHELTER BIOLNG GMBH, Dobl-Zwaring (AT)

(72) Inventors: Matthias REBERNIK, Dobl-Zwaring (AT); Ludwig MICHAL, Raaba-Grambach (AT)

(21) Appl. No.: 18/718,657

(22) PCT Filed: Dec. 14, 2022
(86) PCT No.: PCT/AT2022/060441

§ 371 Date: Jun. 11, 2024

(30) Foreign Application Priority Data
Dec. 15, 2021 (AT) GM 50246/2021

(51) Int. Cl. F17C 5/00

(52) U.S. Cl. CPC F17C 5/007; F17C 2203/03; F17C 2205/0323; F17C 2205/0352; F17C 2221/012; F17C 2223/0161; F17C 2250/0408; F17C 2250/043; F17C 2250/0439; F17C 2250/0491; F17C 2265/065; F17C 2270/0168

(57) ABSTRACT

The disclosure relates to a system that includes a vehicle, a cryogenic container mounted on the vehicle, and an ancillary system for filling the cryogenic container with cryogenic fluid. The ancillary system includes a filling line routed into the cryogenic container and a filling coupling. The cryogenic container is fillable via the filling line. The system may also include a ullage tank for setting a hold time more precisely.

### BACKGROUND

### Background and Relevant Art

The invention relates to a system comprising a vehicle, a cryogenic container mounted on the vehicle, preferably a hydrogen container and particularly preferably an sLH2 container, an ancillary system for filling the cryogenic container with cryogenic fluid, wherein the ancillary system comprises a filling line routed into the cryogenic container and comprising a filling coupling and the cryogenic container is fillable via the filling line.

According to the prior art, liquefied gases can be stored in containers (“cryogenic containers”) so as to be stored as a fuel, for example, for a consumer such as an engine or a fuel cell. Such fluids are present in the cryogenic container at extremely low temperatures, for example, at below 150 Kelvin, so that they are referred to herein as cryogenic fluids. Depending on the temperature and pressure, the cryogenic fluids are present in the cryogenic container in a single-phase mixture or in a two-phase mixture. Classic cryogenic fluids such as LNG (Liquefied Natural Gas) are provided, for example, as a two-phase mixture. In addition to this “classic” cryogenic storage, i.e., the storage of gases in liquefied form, there are also hybrid forms of cryogenic storage, wherein the gases can be present as a two-phase mixture only partly or, respectively, temporarily, but temporarily also as a single-phase mixture, i.e., outside of the thermodynamic wet steam range. The so-called “sLH2 concept” provides, for example, for refuelling with a supercooled fluid (hydrogen) at a supercritical pressure, hence the name “subcooled Liquid Hydrogen”. Other concepts provide for refuelling with a high-pressure gas of up to 350 bar and more, which is, however, −120° C. or even significantly colder (down to −250° C.).

During operation, when the cryogenic fluid is removed from the container and supplied to the consumer, the cryogenic fluid in the cryogenic container is at a working pressure that is, for example, between 6 and 8 bar. When the system is switched off and the removal is stopped, the pressure in the cryogenic container rises again due to the flow of heat into the cryogenic fluid. The same is true after the end of refuelling. To prevent the pressure in the cryogenic container from becoming too high and to avoid damage or, respectively, accidents, the cryogenic container is equipped with a pressure relief valve which activates at a predetermined pressure. In professional circles, the time from when the removal is completed or, respectively, refuelling has ended until the predetermined pressure of the pressure relief valve is reached is referred to as the “hold time”. This is described in detail in WO 2021/102489, for example. Herein, “hold time” is used synonymously with “period of time after which a pressure in the cryogenic container reaches a predefined threshold value”.

If the hold time is exceeded, the pressure relief valve activates and cryogenic fluid is released so that a further increase in pressure is prevented. However, the release of cryogenic fluid constitutes, on the one hand, an economic loss because fuel escapes without having been used, and, on the other hand, an environmental problem because storage efficiency decreases and cryogenic fluid is released into the environment. It is desirable that the hold time of the cryogenic container is as long as possible to enable long shutdown periods, or, respectively, that at least no fuel escapes after the shutdown of the vehicle until its next restart.

Regardless of the above comments about the hold time, it is known for the refuelling of cryogenic containers, in particular hydrogen containers or sLH2 containers, to provide the cryogenic fluid at a filling station at a certain pressure, which is referred to herein as the refuelling pressure. This refuelling pressure is usually just below the pressure at which the pressure relief valve activates. As a result, the largest possible amount of cryogenic fluid can be filled into the cryogenic container so that the vehicle can cover a distance as long as possible.

The usual refuelling process (hereinafter: standard refuelling or normal refuelling) is carried out in such a way that the filling station provides the cryogenic fluid in a cooled state and cryogenic fluid is taken into the cryogenic container using a fuel nozzle or the like. The refuelling process is carried out until the pressure in the cryogenic container corresponds to a refuelling pressure, until a certain fill level is reached or until such point when liquid phase flows back from a vent line. For the refuelling process, the tank pressure must usually be below a certain threshold value—the refuelling start pressure—in order to initiate refuelling. If the tank pressure is above that, it can be lowered, for example, by venting (removing a sufficient partial amount) to at least the refuelling start pressure or below.

During the filling process, the liquid level in the cryogenic container (if the cryogenic fluid is present as a two-phase mixture) increases, with the pressure lying essentially consistently below the refuelling pressure. When the cryogenic container is full, cryogenic fluid, which is usually compressible in this temperature or, respectively, pressure range, can continue to be filled into the cryogenic container. When the pressure in the cryogenic container corresponds to the refuelling pressure, the filling station will no longer be able to fill further cryogenic fluid into the cryogenic container, and the filling process will be terminated on the part of the filling station.

However, filling of this kind is not advantageous in every case, as the hold time after refuelling until such time when cryogenic fluid is released for the first time through the pressure relief valve is extremely short, e.g., spanning only a few hours. However, if the cryogenic container is refuelled to the refuelling pressure shortly before a weekend or another shutdown period, the hold time may be shorter than the shutdown period and the pressure relief valve will activate before the vehicle is put back into operation. As a result, a certain amount of cryogenic fluid is released into the environment via the pressure relief valve during this shutdown period, which constitutes an unnecessary waste of fuel and also environmental damage, respectively. In one theoretical possibility, the quality of the insulation of the cryogenic container could be increased to solve this problem, which, however, is complex and technically hard to implement, or, respectively, not goal-oriented, since usable volume would, in turn, be lost due to a thicker insulating gap.

The documents DE 102015206782 A1 and DE 102019200445 A1 each describe cryogenic containers for vehicles in which refuelling is stopped prematurely so that the cryogenic container will have a longer hold time. However, these methods are not adequate, since, for example, a measurement of the fill level during refuelling is too imprecise in reality. On the other hand, a mere determination of a pressure threshold during refuelling is alone not sufficient in most cases, because the pressure alone is not representative of the current hold time. Furthermore, especially the current fill level also cannot be determined with sufficient accuracy by conducting a direct measurement in the cryogenic container during refuelling.

### BRIEF SUMMARY

It is therefore the object of the present invention to provide solutions to overcome the aforementioned disadvantages.

This object is achieved by a system according to claim 1.

The object according to the invention is achieved in two variants that are linked by the common inventive idea that, in each case, a ullage tank is provided for the cryogenic container and the hold time of the cryogenic container is set in collaboration with said ullage tank.

In the first variant, at least one sensor is connected to the ullage tank, e.g., by a sensor protruding into the ullage tank or being provided at the connection point between the ullage tank and the cryogenic container. Preferably, at least two, at least three or all sensors, from whose measured values the required data are determined, are connected to the ullage tank. A sensor arranged in this way has the advantage that the cryogenic fluid in the ullage tank is calm, since, for example, the cryogenic fluid is first filled into the cryogenic container in which it sloshes around during filling in such a way that, for example, a fill level cannot be measured precisely. Furthermore, local fluctuations in pressure, temperature or density can be caused by the sloshing movements during filling so that a measurement in the ullage container is advantageous also for those measured variables. The thermodynamic state of the cryogenic fluid and consequently also the hold time of the cryogenic container can thereby be determined much more precisely, especially during filling. According to one possibility, the measured value from the ullage container can be used to conclude directly on a corresponding measured value in the cryogenic container. In another possibility, however, a conversion factor can be used to convert a measured value in the ullage tank into a measured value in the cryogenic container, which can be useful especially for pressure measurements, since the pressure in the cryogenic container can rise rapidly, while it will rise more evenly in the ullage tank. As a result, either one or all of the measured values can be measured for the cryogenic fluid present in the ullage tank. Further measured values can optionally be measured in order to determine the thermodynamic state in the actual cryogenic container. It is then determined from these measured values when the refuelling process should be discontinued in order to achieve a specific hold time for the cryogenic container. If at least one measured value is read from the ullage tank, the hold time can be set much more precisely.

In this first variant, the measured value from the sensor connected to the ullage tank is used to terminate the refuelling process prematurely in order to achieve a desired hold time. This occurs preferably on the vehicle side, for example, in that the means comprise a valve arranged directly in the filling line for terminating the refuelling process. Alternatively, the refuelling process can be discontinued prematurely by the filling station, as will be explained in further detail below.

In the first variant, in order to solve the problem of designing the cryogenic container in a more environment-friendly way, it is not envisaged to improve the quality of the insulation, but rather at least a sensor connected to the ullage tank, a computing unit and means are provided with which a desired state of the cryogenic fluid can be achieved during or, for example, essentially immediately after refuelling, in which no cryogenic fluid is released alternately into the environment during a subsequent shutdown period or for the combination of several standstills and planned removals. The means can be designed in various ways, namely as a locking valve in the filling line, as an opening valve for increasing the total volume or as a display or transmitter or transceiver for data that have been determined based on the thermodynamic state and are indicative of the fact that the desired thermodynamic state has been achieved. The means comprise, for example, a computing unit for determining the data required for achieving the desired state, with these data being displayed or transmitted to a filling station. The computing unit can thus conduct an instantaneous comparison as to whether the current thermodynamic state corresponds to the desired thermodynamic state, or can perform a predictive calculation in order to determine data as to how long the refuelling still has to be carried out to achieve the desired thermodynamic state or, respectively, what mass of cryogenic fluid is required in which thermodynamic state in order to achieve the desired thermodynamic state starting from a current thermodynamic state (e.g., the state before refuelling). The data could also be, for example, a signal to indicate that the desired state has been achieved so that the user can terminate refuelling manually. It is understood that, for the calculations, the computing unit can use data stored in the computing unit itself or received from an external unit such as the filling station, such as a quality of the insulation of the cryogenic container or an expected temperature of the cryogenic fluid used for refuelling. In general, it should be noted at this point that the cryogenic fluid in the present invention can be present as a two-phase mixture (gaseous and liquid) or only in a single-phase state. In a two-phase mixture, the mass of the cryogenic fluid can be determined if three measured variables are known, e.g., pressure, temperature and fill level. In a single-phase state, however, the combination of pressure and temperature is sufficient for determining the mass of the cryogenic fluid. However, since the control unit does not always know whether the cryogenic fluid is present in a two-phase mixture or in a single-phase state, further measures can be taken. For example, the signal of the fill level sensor can be used to infer as to whether a two-phase mixture is present or not, or an optical sensor can be used which can determine the transparency of the cryogenic fluid, from which the state of the cryogenic fluid can, in turn, be inferred. This sensor can also be arranged in the ullage tank. Preferably, the computing unit first determines as to whether the cryogenic fluid is single-phase or two-phase and only then calculates the mass.

In the second variant, it is envisaged that the cryogenic container is initially filled up to a refuelling pressure by default and, after refuelling, cryogenic fluid is transferred to the ullage container so that, after refuelling, a thermodynamic state will exist in the cryogenic container in which the vehicle can remain stationary for a desired period of time (e.g., at least 12 hours, 16 hours, 24 hours, 72 hours, 144 hours or 230 hours, but generally freely selectable) without cryogenic fluid being released into the environment during this period. The thermodynamic state is generally understood to be the combination of at least two of the following properties: pressure, temperature, mass. In this application, the volume is constantly specified by the volume of the cryogenic container. However, measured variables by means of which other properties can be determined, e.g., the fill level or the density, can also be used for describing the thermodynamic state.

During standard refuelling, refuelling is terminated when a certain pressure (e.g., the refuelling pressure) or a certain fill level (e.g., the maximum fill level) is present in the cryogenic container, but from this alone it cannot be determined when cryogenic fluid is released into the environment. Even if the user had known that the cryogenic container should not be completely filled in order to extend the hold time, i.e., the period until the cryogenic fluid is first released into the environment after refuelling, the user would not have been able to set the hold time precisely due to a lack of appropriate technical means. On the one hand, a reason for this is that the user does not precisely know the fill level (e.g., the height of the liquid level) during refuelling and would therefore have to guess when an appropriate hold time would be achieved. Setting a well-defined hold time is therefore not possible, of course. On the other hand, even knowing the height of the liquid level is alone not sufficient for determining the current hold time, since the current thermodynamic state of the cryogenic fluid, from which it can be determined as to whether the desired state has been achieved, can only be determined from the combination of at least two measured values, e.g., the height of the liquid level, the pressure and/or the temperature.

Because of the ullage tank, it is possible in particular that its size is related to the desired hold time. This is possible as it can be calculated in advance which volume of cryogenic fluid must be discharged from the cryogenic container after full refuelling in order to achieve a firmly specified hold time or, respectively, time span.

According to the invention, the above-mentioned means optionally comprise a valve arranged between the ullage tank and the cryogenic container for transferring the cryogenic fluid into the ullage tank. In this embodiment, the method of refuelling this system can comprise, among other things, the following steps: closing the valve; filling up the cryogenic container via the refuel coupling according to standard refuelling, e.g., until a predetermined pressure or fill level is present in the cryogenic container; opening the valve. The valve can optionally be re-closed if the current hold time corresponds to the desired hold time. However, this is not absolutely necessary if, as described below, the volume of the ullage tank is chosen already in advance such that the desired hold time emerges at a pressure equilibrium after the valve has been opened. Optionally, the valve to the ullage tank can also be closed only a certain period of time after the start of refuelling in order to partially pre-fill the ullage tank.

Initially, the actual cryogenic container is thus filled completely up to the refuelling pressure and then part of the cryogenic fluid is transferred into the ullage tank, which has not been filled or has been filled only partially during refuelling. The overall system composed of the cryogenic container and the ullage tank is therefore essentially in the same state after refuelling as a cryogenic container for which refuelling has been stopped prematurely.

The above-mentioned ullage tank is usually located on the vehicle and, in particular, can be provided close to the cryogenic container, but could also be part of the filling station, i.e., cryogenic fluid can be returned (“vented back”) to the filling station. In this case, the filling coupling could enable a mass flow of cryogenic fluid in both directions, or a separate return gas line could be provided, which could also be located coaxially in the filling line.

However, it is preferred if the cryogenic container and the ullage tank are surrounded by a common insulating outer shell and, furthermore, the valve is preferably located within the common insulating outer shell. In one variant, for example, an intermediate wall could also be installed in a container, with the larger part of the container being referred to as the cryogenic container and the smaller part of the container being referred to as the ullage tank. In this case, the valve could be located directly in the intermediate wall. In general, it is envisaged that the volume of the ullage tank (if several ullage tanks and/or several cryogenic containers are provided: the total volume of all ullage tanks per cryogenic container) is, for example, at most 30%, at most 20%, at most 10% or at most 5% of the volume of the cryogenic container(s).

On the one hand, the valve could be controllable manually or, respectively, via a computing unit, e.g., by routing a control line from the valve to a manually operable switch or to the computing unit. However, this can be difficult, especially if the valve is located in an isolated area. The problem could indeed be solved if a radio transceiver is used, but, on the one hand, the power supply is problematic in that case, and also, on the other hand, the presence of electrical contacts an such, as the cryogenic fluid can be easily flammable. Currentless switchings of the valve can be achieved, for example, if the valve is a pressure relief valve that opens in the direction of the ullage tank, when a transfer pressure prevails in the cryogenic container that is above a refuelling pressure. For example, the refuelling pressure can be 16 bar, and the transfer pressure can be 18 bar. This embodiment thus has the advantage that the valve does not have to be designed to be controllable and the safety of the system is therefore increased. In contrast, controllable valves have the advantage of a more flexible switching, as the valve could also be open during the refuelling process, for example. Thus, the valve could preferably be amenable to be brought into a second operating state in which the cryogenic container and the ullage tank are fillable according to a standard refuelling process.

Thus, if the valve between the cryogenic container and the ullage tank is designed as a pressure relief valve, cryogenic fluid is first moved from the cryogenic container to the ullage tank, when the transfer pressure is reached, and then, when essentially the same pressure prevails in the cryogenic container and in the ullage tank, cryogenic fluid is released into the environment from the cryogenic container and/or the ullage tank, when the pressure of the outward-opening pressure relief valve is reached. In all embodiments, the outward-opening pressure relief valve can release cryogenic fluid from the cryogenic container and/or the ullage tank toward the outside. Optionally, two outward-opening pressure relief valves could also be provided, with one being attached to the cryogenic container and one being attached to the ullage tank.

Furthermore, a check valve can preferably be provided between the cryogenic container and the ullage tank, which only allows fluid to flow from the ullage tank to the cryogenic container. As a result, cryogenic fluid can be constantly removed from the ullage tank, for example, if it is needed for a removal. However, if the first-mentioned valve is designed to be switchable, the check valve could also be omitted, e.g., if the first-mentioned valve is opened during a removal.

In general, the system therefore comprises means for achieving or, respectively, setting a desired hold time during or after refuelling, using a ullage tank. It should be noted at this point that what is meant by achieving the desired hold time “during refuelling” is that the refuelling process is discontinued prematurely or that an end is put to refuelling at the point in time that has been determined for the desired hold time. What is meant by achieving the hold time “after refuelling” is that a conventional refuelling process is carried out, e.g., according to the prior art, and the refuelling process is terminated when, for example, a pressure corresponding to the refuelling pressure prevails in the cryogenic container. Afterwards, the ullage tank is switched on or vented towards the filling station in order to achieve the desired hold time. Furthermore, it should be noted that, in a refuelling process according to the invention, venting during (simultaneously with or interrupting the filling process) or as a conclusion to the refuelling process can also be useful in order to bring about a desired pressure condition in the cryogenic container.

Furthermore, it is preferred if the volume of the ullage tank is chosen in relation to the volume of the cryogenic container such that the desired thermodynamic state of the cryogenic fluid is attained after a pressure equilibrium has been established between the ullage tank and the cryogenic container with the valve open, after complete filling with the valve closed, with the desired hold time preferably equating at least 12 hours, 16 hours, 24 hours, 72 hours, 144 hours or 230 hours. In this case, the valve merely has to be opened after complete filling, whereupon a predetermined portion of cryogenic fluid flows into the ullage tank. However, the desired hold time or, respectively, the desired state is predetermined by the size of the ullage tank in this case and cannot be increased any further, unless this embodiment is combined with a valve in the refuel line or by individual refuelling, as described below for the figures. The end of refuelling could be indicated manually or, for example in a simple form, could be automatically connected to the sensor for indicating the position of the tank flap of the filling coupling, whereby the valve to the ullage tank opens or, respectively, closes as soon as the tank flap sensor declares “closed” or vice versa.

It is also possible for several ullage tanks to be provided so that, by switching on one ullage tank in addition, a hold time of 12 hours is achieved, for example, and, by switching on two ullage tanks in addition, a hold time of 24 hours is achieved, for example. This can be achieved by providing at least one further ullage tank and at least one further valve between the cryogenic container and the further ullage tanks or between the ullage tank and the further ullage tanks, wherein the further valves can be opened individually to selectively set a hold time after a refuelling process. On the one hand, the valves can connect the individual ullage tanks directly to the cryogenic container and, on the other hand, a cascade-like placement of the ullage tanks could be provided, whereby the ullage tanks are filled only consecutively.

Thus, in the simplest embodiments, the system does not need to have any sensors at all for the hold time to be adjustable, e.g., if the user knows that the hold time is extended by 12 hours by switching on the ullage tank in addition after refuelling, and the ullage tank can be switched on in addition by simply pressing a button. This is preferred because measuring by means of sensors can be complex and also inaccurate. In particular, a fill level is difficult to measure during refuelling due to the sloshing cryogenic fluid.

In other variants, however, the system could also comprise sensors to determine the thermodynamic state of the cryogenic fluid in the cryogenic container and/or in the ullage tank, with the system furthermore comprising a computing unit designed for determining a current hold time of the cryogenic container, and/or with the computing unit being designed for determining data as to how the valve is to be operated, based on the thermodynamic state determined by the sensors, so that the desired state is achieved.

In particular, the computing unit can be connected to the valve and can actuate it directly in order to bring the cryogenic fluid in the cryogenic container into a state in which the pressure in the cryogenic container does not reach a predefined threshold value without any removal or taking into account planned removals of cryogenic fluid within a desired period of time. Alternatively, these data could also be indicated on a display so that a user can actuate the valve manually.

In the first variant, as already explained, said means preferably comprise a valve arranged directly in the filling line for terminating the refuelling process (however, this can also be combined with the second variant). Such a valve can be designed in particular for switching into a closed state in the cryogenic container during a filling process, e.g., even before the refuelling pressure is achieved with which the cryogenic fluid is provided at the filling coupling (or, respectively, even before a predetermined liquid level is reached at which standard refuelling is completed or even before liquid phase flows back from a vent line if standard refuelling is terminated when the backflow is detected), if a current hold time of the cryogenic container corresponds to the desired hold time. The method of refuelling in this system comprises, among other things, the steps of: opening the valve; refuelling the cryogenic container via the refuel coupling; closing the valve when the desired thermodynamic state in the cryogenic container has been achieved.

Thus, in this embodiment, a valve located in the filling line can, for example, be closed prematurely in order to end the refuelling process. In this way, it is accomplished that the filling process is discontinued prematurely at this point in time, which allows a longer hold time of the cryogenic container in comparison to full refuelling. If the vehicle is now switched off for a shutdown period of, for example, two days, the pressure in the cryogenic container will rise, but due to the refuelling that has been chosen to be incomplete, no cryogenic fluid will escape through the pressure relief valve as a so-called boil-off. If this situation is compared to a state-of-the-art system in which the cryogenic container has been fully refuelled prior to the shutdown period and thus releases excess cryogenic fluid as a boil-off during the shutdown period, essentially the same amount of cryogenic fluid will be present in the cryogenic container after the shutdown period for both cryogenic containers, although in the cryogenic container according to the invention no cryogenic fluid is wasted, i.e., released into the environment.

Alternatively, in the first variant, a thermodynamic state can also be set in which the desired time period is shorter than with standard refuelling. In this case, the filling station supplies, for example, colder cryogenic fluid than during normal refuelling and the valve closes as soon as the required mass has been filled into the cryogenic container, or the refuelling process could be carried out up to a higher pressure than with normal refuelling. As a result, a larger mass of cryogenic fluid can be filled into the cryogenic container than with normal refuelling.

The same effect can alternatively be achieved with the above-mentioned second variant according to the invention. In the second variant, the above-mentioned means usually comprise a valve arranged between the ullage tank and the cryogenic container for transferring the cryogenic fluid into the ullage tank. In this embodiment, the method of refuelling this system comprises, among other things, the steps of: closing the valve; filling up the cryogenic container via the refuel coupling according to standard refuelling, e.g., until a predetermined pressure or fill level is present in the cryogenic container; opening the valve. The valve can optionally be re-closed if the current hold time corresponds to the desired hold time. However, this is not absolutely necessary if, as described below, the volume of the ullage tank is chosen already in advance such that the desired hold time emerges at a pressure equilibrium after the valve has been opened. Optionally, the valve to the ullage tank can also be closed only a certain period of time after the start of refuelling in order to partially pre-fill the ullage tank.

In this second variant, the same objective is achieved as in the first-mentioned variant, i.e., it is rendered possible that, after a refuelling process carried out by the filling station in a conventional way, a degree of filling as full as possible is provided, which, however, is slightly reduced compared to maximum refuelling in order to enable a longer hold time. In contrast to the first variant, the actual cryogenic container is completely filled up to the refuelling pressure, and then part of the cryogenic fluid is transferred to the ullage tank, which was not filled during refuelling. The overall system composed of the cryogenic container and the ullage tank thus has essentially the same state after refuelling as the cryogenic container from the first variant.

The above-mentioned ullage tank is usually located on the vehicle, in particular in or, respectively, on the cryogenic container, but could also be part of the filling station, i.e., cryogenic fluid can be returned (“vented back”) to the filling station. In this case, the filling coupling could enable a mass flow of cryogenic fluid in both directions, or a separate return gas line could be provided, which could also be located coaxially in the filling line.

In particular, it can also be envisaged that the valve between the cryogenic container and the ullage tank is designed as a pressure relief valve, which activates, for example, before a further pressure relief valve releases cryogenic fluid into the environment. In this embodiment, cryogenic fluid is first taken from the cryogenic container to the ullage tank when a first pressure threshold is reached, and then, when essentially the same pressure prevails in the cryogenic container and in the ullage tank, cryogenic fluid is released from the cryogenic container and/or the ullage tank into the environment when a second pressure threshold is reached.

In both of the variants mentioned, said means can also comprise a display, with the computing unit being designed for determining a mass required for achieving the desired state, optionally in combination with a required pressure and/or a required temperature, and/or a current period of time until the predefined threshold value is reached and/or a current mass of the cryogenic fluid in the cryogenic container, optionally in combination with a current pressure in the cryogenic container and/or a current temperature in the cryogenic container, or the fact that the desired state has been achieved and for indicating that on the display. The user can thus decide for themselves on the basis of the information displayed, e.g., the current hold time, as to whether the refuelling process should be discontinued prematurely or whether cryogenic fluid should be transferred to the ullage tank after a refuelling process. For example, if it is displayed that the hold time is 8 hours, but the user knows that they will continue their journey not earlier that in 12 hours, they can discharge cryogenic fluid into the ullage tank after refuelling. By contrast, if they do not wish a longer hold time, they can just fill up the ullage tank simultaneously to maximize the mass of cryogenic fluid carried along. In any case, it is also preferable for the display if the displayed information includes at least one processed or unprocessed measured value of a sensor connected to the ullage tank, since, as already explained above, this allows a better conclusion to be drawn about the current hold time. However, in the variant in which cryogenic fluid is discharged into the ullage tank after refuelling, all measured values could also be obtained from sensors not connected to the ullage tank, but connected only to the cryogenic container, for example.

In one embodiment, data can be determined by the computing unit which are indicative of the current hold time, e.g., the hold time itself or the mass of cryogenic fluid in the cryogenic container. Alternatively, the mass required for achieving the desired state could be calculated. The data determined by the computing unit can be indicated on the display so that the user can manually discontinue the refuelling process when the desired state has been achieved, or, respectively, so that the user can manually transmit the required data to the filling station, e.g., being able to enter them into an interface of the filling station.

In a further embodiment, the means can comprise a transmitter for transmitting data to a filling station, the computing unit being designed for determining a mass required for achieving the desired state, optionally in combination with a required pressure and/or a required temperature, and/or a current period of time until the predefined threshold value is reached and/or a current mass of the cryogenic fluid in the cryogenic container, optionally in combination with a current pressure in the cryogenic container and/or a current temperature in the cryogenic container, or the fact that the desired state has been achieved and for transmitting that to the filling station.

In this embodiment, the filling station can independently conduct the refuelling process in such a way that the cryogenic fluid in the cryogenic container has the desired thermodynamic state after refuelling, and provides for this purpose, for example, a required mass of cryogenic fluid in a required thermodynamic state. It will be appreciated that the computing unit can perform a conversion in order to convert a required mass in a required thermodynamic state into another mass in another thermodynamic state. Optionally, the computing unit and/or the filling station can have an interface for entering the desired period of time so that the required mass of cryogenic fluid, optionally in combination with a thermodynamic state, can be calculated therefrom.

In the simplest embodiment, the above-mentioned valves can be operated manually. In the first variant, for example, a display indicating the current period of time/hold time or, respectively, the mass of cryogenic fluid in the cryogenic container, which have been calculated from the measured values, could be visible to the person refuelling. The person refuelling can activate the valve manually in order to complete refuelling. In this case, the means would again comprise a display and optionally a computing unit for calculating the data. In the second variant, the valve can simply be opened manually after complete refuelling and, if necessary, can be re-closed after a certain period of time.

Alternatively or additionally, the valve could also be closed or, respectively, opened automatically in both variants. The computing unit already illustrated is preferably used in this case.

It is particularly preferred if the above-mentioned system comprises a pressure sensor and/or a temperature sensor and/or a density sensor and/or a liquid level sensor and/or a weight sensor, with the computing unit being connected to at least two of said sensors and being designed for determining, from measured values received from the sensors, a mass required for achieving the desired state, optionally in combination with a required thermodynamic state such as a required pressure and/or a required temperature, and/or a current period of time until the predefined threshold value is reached and/or a current mass of the cryogenic fluid in the cryogenic container, optionally in combination with a current pressure in the cryogenic container and/or a current temperature in the cryogenic container, or the fact that the desired state has been achieved. As already explained, it is preferable if at least one of these sensors is connected to the ullage tank, as this allows the hold time to be inferred more precisely. The hold time can be calculated either analytically or by storing a formula or a table in the computing unit. Since the hold time is normally dependent on other factors such as an insulation quality or a volume of the cryogenic container, such factors can be stored in the computing unit. The current mass or, respectively, hold time can also depend on the condition provided by the filling station, in particular the temperature of the cryogenic fluid flowing into the tank. Said condition can be detected, for example, by measuring the temperature and can be additionally included as a calculation factor when determining the mass or, respectively, hold time, or the filling station could send the condition, in particular the temperature, to the computing unit using a transmitter.

Subsequently, the refuelling process can be controlled, in particular terminated, using the data determined by the computing unit.

As already explained, the computing unit can either output the hold time on a display for a user, with the user operating the valve manually. Alternatively or additionally, the computing unit could also be connected to the valve and could be designed for closing the valve when the desired state has been achieved. Alternatively or additionally, the computing unit could open the valve for the ullage tank as soon as a standard refuelling process has been completed, which could also be done without determining the height of a liquid level, a pressure or the hold time. The point in time when the cryogenic container has been completely filled at the refuelling pressure can be determined directly by measuring a pressure in the cryogenic container, or via a control line between the computing unit and the filling coupling, which indicates the end of the refuelling process.

In all aforementioned embodiments, the valve thus serves the purpose of enabling a longer hold time for the cryogenic container if a longer shutdown period is expected immediately after refuelling. In some cases, however, it is desired that driving continues immediately after refuelling. In this case, even with complete refuelling, it is not to be expected that boil-off will be discharged from the cryogenic container, since cryogenic fluid is immediately removed from the cryogenic container. It is therefore advantageous if the valve can be brought into a second operating state in which the cryogenic container and also the ullage tank can be filled up to the refuelling pressure. In other words, the cryogenic container can be filled in a state in which the hold time is below the desired hold time of the cryogenic container. The valve can preferably be brought into the second state manually, e.g., using a button of an automatically actuated valve, so that the person refuelling can choose, e.g., before or during refuelling, as to whether the cryogenic container is filled up in the state in which the hold time is extended, or is filled up in the state in which the fill quantity is maximized. The desired hold time or, respectively, the desired state of refuelling can be chosen manually via an interface or can also be specified by a program such as a route planner, which could additionally specify also the amount of cryogenic fluid required for a journey. This calculation could also comprise several shutdown periods with or without a removal, e.g., a weekend with the heater or refrigerator in operation, and several operating times one after the other for an entire route. In this case, the “hold time” can also be desired so that it is achieved only after at least one interruption (removal).

In a particularly preferred embodiment, the system could comprise a further cryogenic container mounted on the vehicle, wherein a further filling line is connected to the first-mentioned filling line and routed into the further cryogenic container so that both the first-mentioned cryogenic container and the further cryogenic container can be filled up via the filling coupling. Preferably, both cryogenic containers have their own ullage tank and/or a or the computing unit is connected to a valve in the filling line and to a valve in the further filling line and is designed for setting an equal time period for the two cryogenic containers until the predefined threshold value is reached by actuating those two valves. The two valves can be set, for example, in such a way that the hold time of the two cryogenic containers remains the same during the entire refuelling process or is the same at least after the refuelling process. Only one ullage tank could be provided so that both cryogenic containers discharge cryogenic fluid into the same ullage tank after refuelling, or two ullage tanks could be provided and the two cryogenic containers discharge cryogenic fluid after refuelling into the ullage tank allocated to them, in which case the ullage tank is preferably always arranged directly next to the respective cryogenic container in a common insulating outer shell.

The system described herein is usually implemented such that the cryogenic container is mounted on the side of a vehicle frame of the vehicle. In this case, the filling coupling can also be accessible on the side of the vehicle, whereby conduction paths can be minimized. The aforementioned displays can be visible directly next to the filling coupling or in the driver's cab or as part of the vehicle's operating system or on mobile devices or displays.

In all aforementioned embodiments, it is furthermore preferred if the system comprises a journey planning unit in which at least one next route to be driven is stored or can be determined, wherein also the time of the start of the journey for this route is stored or can be determined, and the journey planning unit is designed for selecting the desired hold time and optionally a required mass of cryogenic fluid for a given thermodynamic state so that the cryogenic fluid is maximized or will at least be sufficient for reaching a next filling station on the route, and so that the pressure in the cryogenic container is not reached until the time of the start of the journey or (should this be necessary for reaching a next filling station) is reached only for the shortest possible time, i.e., the desired hold time should correspond at least to the shutdown period, optionally taking into account an anticipated removal during the shutdown period. As a result, the refuelling parameters (e.g., the mass of the cryogenic fluid which is to be added by refuelling or the point in time when a valve such as the valve is to be closed) can be determined fully automatically. This journey planning unit can be connected to the computing unit, or the journey planning unit and the computing unit can be designed together.

In a further aspect, the invention relates to a filling station for refuelling the above-mentioned system, wherein the filling station is designed for transmitting data about the cryogenic fluid used for refuelling, in particular a temperature and/or a pressure, to the computing unit, and/or for receiving data about the current thermodynamic state or data about a required mass with a required temperature and a required pressure from the computing unit and for providing cryogenic fluid with the required mass, the required temperature and the required pressure so that the cryogenic fluid in the cryogenic container has the desired thermodynamic state after the refuelling process has ended. This filling station thus provides cryogenic fluid in exactly the required thermodynamic state (i.e., mass, temperature and pressure) so that the cryogenic container will have the desired hold time after refuelling. The termination of the refuelling process is thus performed by the filling station, and the part of the system located on the vehicle does not need to have any separate valves. However, the valves for ending the refuelling process could still be carried along on the vehicle, for example, in order to exploit the inventive effect even at filling stations that have not been specially designed.

This filling station could also be part of said system and could preferably comprise a receiver for receiving the data transmitted by said transmitter, the filling station being designed for terminating a refuelling process depending on the data received or, respectively, for providing cryogenic fluid with a required mass, temperature and pressure in order to set the desired hold time of the cryogenic container. Optionally, the filling station has a computing unit to determine the current hold time of the cryogenic container or the required mass of cryogenic fluid from the received data so that the desired hold time is present in the cryogenic container after the refuelling process.

### BRIEF DESCRIPTION OF THE DRAWINGS

Advantageous and non-limiting embodiments of the invention are explained in further detail below with reference to the drawings.

FIG. 1 shows a schematic view of a cryogenic container comprising a ullage tank for premature discontinuation of refuelling.

FIG. 2 shows a schematic view of a cryogenic container comprising a ullage container for changing the hold time after standard refuelling.

FIG. 3 shows a chart in which the ratio of the hold time of the cryogenic container in relation to the mass of the cryogenic fluid in the cryogenic container is illustrated.

FIG. 4 shows a chart in which the pressure conditions in the cryogenic container during refuelling are illustrated.

FIG. 5 shows an alternative embodiment to FIG. 2.

FIG. 6 shows a chart analogous to FIG. 3 for an embodiment with a ullage tank.

FIG. 7 shows a schematic view of a cryogenic container which can be filled up individually via a filling station.

FIGS. 8 and 9 each show systems with two cryogenic containers.

FIGS. 10 and 11 show two embodiments with two ullage containers.

### DETAILED DESCRIPTION

FIG. 1 shows a system 1 with a cryogenic container 2 that is mounted on a vehicle (not shown in more detail). For example, the vehicle has a support frame and two axles, wherein one cryogenic container 2 can, in each case, be mounted on one or both sides of the support frame between the axles. The vehicle is usually a road vehicle with at least four wheels, but could also be a train, an aircraft, a ship, a submarine or the like.

The cryogenic container(s) 2 each store cryogenic fluid, in particular hydrogen, so that the cryogenic container 2 is a hydrogen container. Alternatively, the cryogenic fluid could also be LNG (Liquefied Natural Gas) so that the cryogenic container is an LNG container. Depending on the cryogenic fluid, the cryogenic container 2 is thus designed for storing cryogenic fluid at temperatures of, for example, below 150 Kelvin, in case of hydrogen even of below 50 Kelvin or below 30 Kelvin or essentially of 20 Kelvin. Depending on the application, the cryogenic container 2 could be designed, for example, for storing sLH2 (subcooled liquid hydrogen) or CcH2 (cryo-compressed hydrogen) and thus also for corresponding high pressures, for example for maximum pressures of between 1 bar and 350 bar.

The cryogenic fluid can be present in the cryogenic container 2 both in a liquid form and in the gaseous state, with the term “fill level” denoting the height of the liquid form of the cryogenic fluid when the cryogenic fluid is present as a two-phase mixture. In case of single-phase mixtures, the mass of cryogenic fluid present in the cryogenic container at any given time can be determined and, in relation to the maximum mass, it can be referred to as the fill level. Since the cryogenic container(s) 2 is/are used in combination with a vehicle, the stored cryogenic fluid can serve, for example, as a fuel for a consumer such as an engine or a fuel cell of the vehicle.

In order to introduce cryogenic fluid into the cryogenic container 2 or, respectively, remove it from the cryogenic container 2, the system 1 comprises an ancillary system comprising a filling line 3, which is routed into the cryogenic container 2 at one end and comprises a filling coupling 4 at the other end. A fitting of a filling station, such as a fuel nozzle, can be attached to the filling coupling 4 in order to fill up the cryogenic container 2. Furthermore, the ancillary system can comprise a first removal line 5 and/or a second removal line 6. The first removal line 5 can be connected to the filling line 3 so that cryogenic fluid is both introduced into and removed from the cryogenic container 2 via a section of the filling line 3. During refuelling, a valve 7 in the removal line 5 can be closed and opened for removal. Alternatively or additionally, the second removal line 6 can be provided, which is routed into the cryogenic container 2 independently of the filling line 3. In some cases, two separate removal lines 5, 6 are provided in order to selectively remove cryogenic fluid in the gaseous state or in the liquid state. In general, the removal line 6 could also be connected to the filling line 3.

If the system 1 is in operation, the pressure in the cryogenic container 2 is, for example, between 6 and 8 bar. This pressure can be regulated during the operation of the vehicle, for example, by removing cryogenic fluid or by a heat exchanger projecting into the respective cryogenic container. However, as soon as the system 1 is no longer in operation, i.e., has been switched off, the pressure in the cryogenic container 2 rises steadily due to a constant heat input into the cryogenic container 2.

In order to prevent excessive pressure in the cryogenic container 2 and consequently a defect of the latter, the cryogenic container 2 usually has a pressure relief valve 8, which can be connected directly or indirectly to the cryogenic container 2 via a connecting line 9. The pressure relief valve 8 could also be connected to the filling line 3 or the removal line 5, 6. The pressure relief valve 8 activates at a predetermined pressure, which amounts to, for example, 20 barg, and, in doing so, releases cryogenic fluid in a gaseous state, which is also referred to as boil-off.

The period of time from a current point in time, in particular from a termination of the removal or, respectively, a termination of refuelling, to a point in time when the pressure in the cryogenic container 2 reaches a predefined threshold value (e.g., an activation pressure of the pressure relief valve 8), is referred to as the so-called hold time. If, in this connection, mention is made of a current hold time during refuelling, what is meant is the current hold time that would be provided if refuelling were abruptly discontinued at this point in time. It will be understood that the hold time of the cryogenic container 2 should be as high as possible, as discharged cryogenic fluid constitutes an economic loss and damage to the environment. When calculating the hold time, it can be assumed that the mass of cryogenic fluid in the cryogenic container 2 will remain constant during this period of time, or an anticipated removal, e.g., a minor removal for the power supply in the driver's cab, can be taken into account, or a removal can also be planned for a certain route, e.g., within a fleet.

The current hold time of the cryogenic container 2 can be calculated by taking the current thermodynamic state of the cryogenic fluid in the cryogenic container 2 as a basis and calculating (e.g., extrapolating) when the pressure of the cryogenic fluid reaches the predefined threshold value due to an external heat input. For calculating the external heat input, on the one hand, the ambient temperature can be used, which can also be determined for the present invention and can be included in the calculation. Furthermore, the container volume, the container surface, the insulation quality can be used to convert the ambient temperature to the heat input. This calculation is known per se, or, in the simplest case, a constant heat input can also be used, so this shall not be discussed any further herein. In order to refine the calculation, a thermal inertia of the system can also be taken into account.

However, the primary factor for calculating the hold time is a determination of the current thermodynamic state of the cryogenic fluid, as it will have the greatest impact on the hold time. For this purpose, for example, the current mass of the cryogenic fluid in the cryogenic container 2 is determined, which, in the simplest case, can be determined directly by weighing the cryogenic container or by evaluating mechanical stresses on the cryogenic container 2. However, the mass of the cryogenic fluid can also be determined from a combination of at least two thermodynamic measured values, e.g., the pressure, the temperature, the density and/or the height of the liquid level (if the cryogenic fluid is present as a two-phase mixture). Thereupon, the hold time can be calculated from the mass, in combination with a measured value relevant to the thermodynamic state, in particular the pressure or the temperature. However, the hold time could generally also be determined without the intermediate step of calculating or, respectively, determining the mass, for example, if at least two or at least three of the aforementioned thermodynamic measured values are provided to a computing unit or a filling station. However, current status data are also preferably sent to the filling station, e.g., a current pressure, fill level, temperature, etc., during refuelling, whereby the accuracy of the calculation can be increased. In summary, the period of time after which the pressure in the cryogenic vessel 2 will reach a predefined threshold value can be determined based on the knowledge about the current thermodynamic state.

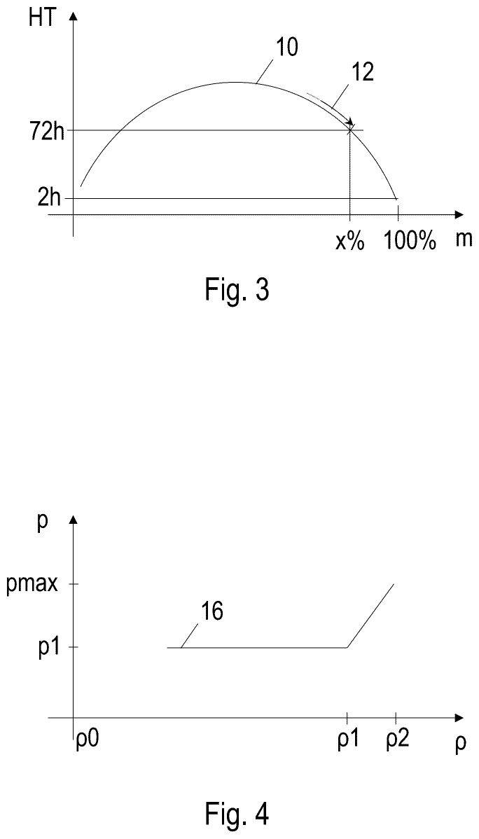

In this context, reference is made to FIG. 3, which shows the relationship between the mass m located in the cryogenic container 2 and the hold time for a specific thermodynamic initial state or, respectively, final state (herein for a specific pressure). The mass m is plotted on the x-coordinate in %, with 100% of the mass being present at the filling pressure when the cryogenic container 2 is filled up fully. The hold time, which is measured in hours h, is plotted on the y-coordinate. It is evident that the hold time can be determined directly from the mass if the thermodynamic state is known. Hence, if it is suggested in this case that a current hold time is calculated or, respectively, displayed, this is essentially equivalent to the statement that a current mass is calculated or, respectively, displayed at a known pressure or, respectively, at a known temperature of the cryogenic fluid. For example, one or several tables could be stored in a computing unit, or one or several tables (e.g., several tables each for a specific pressure) could be indicated alongside a display in order to simplify the conversion.

In general, the curve 10 shows that the hold time is short when the cryogenic container 2 is almost empty. By filling up the cryogenic container 2, the hold time is also increased until the cryogenic container 2 is, for example, half full, whereupon the hold time goes back down with further refuelling.

It is evident from FIG. 3 that the hold time equals, for example, only two hours at a maximum filling of 100%, i.e., after 2 hours the pressure in the cryogenic container 2 will rise to the activation pressure of the pressure relief valve 8 so that boil-off is discharged from the pressure relief valve 8. However, if the cryogenic container 2 were only partially filled, in the present example by x %, the hold time would be three days (72 h), i.e., after refuelling three days would pass until the pressure relief valve 8 releases boil-off from the cryogenic container 2 for the first time. According to the invention, it is envisaged that a desired hold time is set, after which cryogenic fluid is released from the cryogenic container 2 for the first time after refuelling.

According to the invention, a desired hold time can be set during or after refuelling using means that can be implemented in various embodiments and are described below. In general, the desired hold time is not equal to the hold time which is achieved after normal refuelling, e.g., after continuous refuelling at a specified refuelling pressure or after refuelling which ends at the maximum fill level. The desired hold time can be specified by a user, e.g., if the user plans not to use the vehicle during a certain shutdown period. Furthermore, a journey planning unit such as a route planner could also specify the desired hold time, e.g., if the route planner calculates or, based on a timetable or a current time of day (e.g., the end of work) or weekday (e.g., the last day before the weekend or a public holiday), anticipates that the vehicle will not be put into operation for a certain period of time. However, if a desired hold time is specified, it does not have to correspond to the shutdown period, but, for example, a removal anticipated for the shutdown period, e.g., a minor removal because of a heater in the driver's cab or the like, can also be taken into account. The desired hold time can thus also correspond to a shutdown period in consideration of an expected removal.

Returning to FIG. 1, the setting of the hold time is enabled in a first embodiment in such a way that a valve 11, which can be closed and opened manually or in an actuated manner, is arranged in the filling line 3. If, for example, a desired hold time of three days is to be set, the valve 11 is initially open during refuelling so that the cryogenic container 2 is filled up from left to right along the curve 10 in FIG. 3. Since the hold time decreases with further refuelling, beginning at a certain mass, the valve 11 should lock when the desired hold time, in this example three days, is achieved. This refuelling is indicated by the arrow 12, which ends at the mass of x %, which corresponds to the desired hold time of three days.

If the valve 11 is closed, a pressure corresponding to the refuelling pressure will be established at the refuel coupling 4, i.e., on the side of the valve 11 facing away from the cryogenic container 2. From the perspective of the filling station, the situation is now as if the cryogenic container 2 was completely filled up. The filling station now ends the refuelling process on its part. Depending on the embodiment, the filling station does not even have to be modified for this purpose or, respectively, does not require any further exchange of information with the above-mentioned system of the vehicle via an electronic interface, since the pressure alone acts as the termination signal.

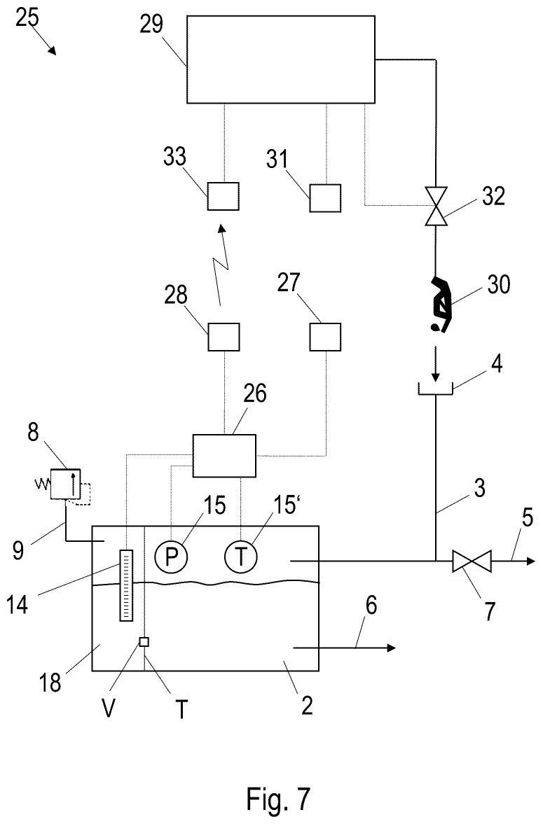

In order to actuate the above-mentioned valve 11, a computing unit 13 can be provided, for example, which determines the current hold time and closes the valve 11 when the desired hold time is achieved. In general, the computing unit determines as to whether a thermodynamic state of the cryogenic fluid in the cryogenic container 2 has been achieved in which the pressure in the cryogenic container 2 does not reach a predefined threshold value without any removal or taking into account planned removals of cryogenic fluid within a desired period of time. The planned removals can be fed manually into the computing unit via an interface or can be stored therein (e.g., if 30 watts are required for electronics during a standstill). The computing unit 13 could also calculate data to determine as to when or, respectively, how this desired thermodynamic state is achieved, e.g., that the desired state is achieved if the current refuelling continues for another 30 seconds or that 50 kg at 5 bar and 22 Kelvin or 50 kg at 200 bar and 120 Kelvin are required in order to achieve the desired state. This is particularly advantageous for the embodiments of FIG. 7 explained below.

In order to determine the current hold time or, respectively, the current thermodynamic state, the computing unit 13 can be connected to a liquid level sensor 14 and/or a pressure sensor 15 and/or a temperature sensor 15′ and/or a density sensor and/or a weight sensor, each of them measuring a thermodynamic state of the cryogenic fluid in the cryogenic container 2. Since, particularly in case of sLH2, the cryogenic fluid is compressible under the conditions prevailing in the cryogenic container 2, the height of the liquid level or the pressure alone is generally not sufficient for directly determining the hold time, or a single-phase mixture and hence no fill level is present particularly at the refuelling pressure so that a combination of these two measured values may be necessary. The computing unit 13 then determines the current hold time based on the received measuring data applying the considerations described above, optionally taking into account a measured value of the ambient temperature or a thermal inertia. Thus, the cryogenic container, which is described herein, particularly preferably stores cryogenic fluids which are compressible during refuelling at least temporarily. However, this is not mandatory.

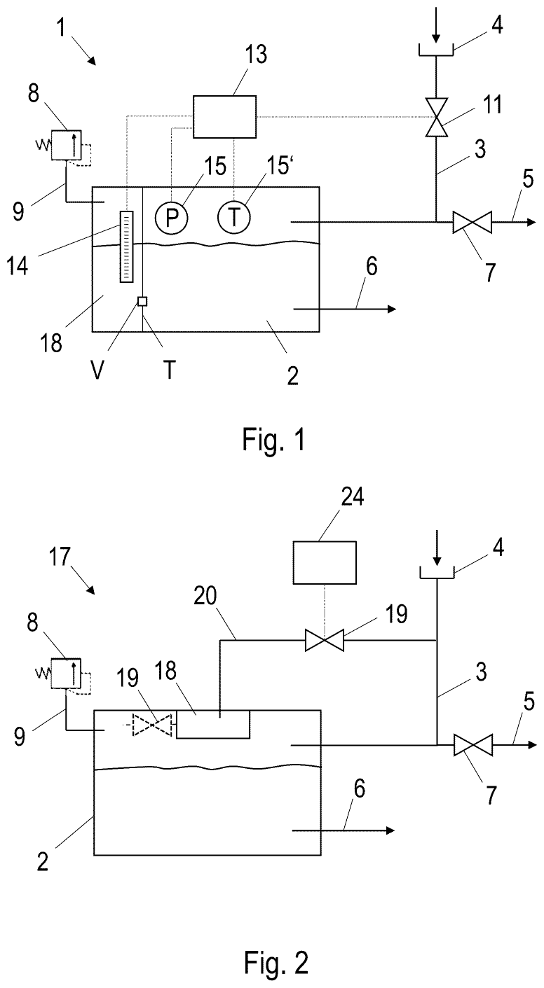

However, since the cryogenic fluid sloshes especially during the refuelling process and local density differences and temperature differences may occur, it is envisaged that at least one of the above-mentioned sensors is not located in the cryogenic container 2, but in a ullage tank 18 that is separate from it and can have the properties mentioned below. The ullage tank 18 can be achieved in particular by installing a dividing wall T in an insulated container so that the dividing wall T separates the ullage tank 18 from the cryogenic container 2. Alternatively, the ullage tank 18 could be manufactured from a curved partial container (FIG. 2). In this case, it can be said that the ullage tank 18 and the cryogenic container 2 are located within the same insulating outer shell. Alternatively, the ullage tank 18 exists as a specially insulated container so that the ullage tank 18 and the cryogenic container 2 can be connected by a line.

In order to achieve fluid communication between the ullage tank 18 and the cryogenic container 2, there can be, for example, a permanent opening V or a line between the ullage tank 18 and the cryogenic container 2, the cross-sectional area of which preferably does not exceed 75 mm² or preferably does not exceed 100 mm². However, the opening particularly preferably ranges from approximately 1 mm² to 4 mm². Again, the cross-sectional area of the opening V is preferably at most 25%, preferably at most 10%, preferably at most 5% or preferably at most 2% of the cross-sectional area of the filling line 3. Cryogenic fluid can flow from the cryogenic container 2 into the ullage tank 18 through this small opening V or, respectively, through the line, whereby the ullage tank 18 will be filled more steadily and more precise measured values can be determined for determining the thermodynamic state of the cryogenic fluid. For example, sloshing does not occur in the ullage tank because of the inflow through the limited opening V so that the fill level can be determined more precisely. The pressure and the temperature in the ullage tank 18 are also more uniform so that these measured values in the ullage tank 18 can also be determined more precisely.

If the thermodynamic state of the cryogenic fluid is to be determined, at least one measured value from the ullage tank 18 can be used, preferably the fill level, and, if necessary, further measured values from the cryogenic container 2.

Instead of a permanent opening, an actuatable valve or a pressure relief valve opening in the direction of the ullage tank (optionally, in each case, in combination with a check valve 70 opening in the direction of the cryogenic container 2) can also be used, as described below for the valve 19.

The sensor can also be present in the valve or, respectively, in the opening between the cryogenic container 2 and the ullage tank 18. If the valve is designed, for example, as a pressure relief valve, the activation pressure can be used, for example, as the pressure prevailing at the time of activation. Alternatively or additionally, the activation could be detected indirectly from the pressure profile or, respectively, the change in pressure profile in the cryogenic container 2 or in the ullage tank 18.

The refuelling behaviour of the cryogenic fluid is now explained in further detail on the basis of FIG. 4. In this case, the density of the cryogenic fluid is plotted on the x-axis, and the pressure in the cryogenic container 2 is plotted on the y-axis, with pmax denoting the refuelling pressure and p1 denoting the pressure that arises due to the temperature conditions of the cryogenic fluid without excess pressing. The curve 16 shows the function of the density in relation to the pressure for sLH2 as the cryogenic fluid. The section of the curve 16 at a low density (i.e., at a low fill level) is not illustrated for the sake of simplicity. In this case, the density is understood to be the average density of the cryogenic fluid in the cryogenic container 2, i.e., the total mass divided by the container volume. The constant pressure p1 between the densities p0 and p1 indicates that the fill level increases essentially constantly, at least in the area of the curve 16 that is shown, i.e., the liquid level in the cryogenic container 2 rises steadily. However, when the density p1 is reached, the fill level or, respectively, the density is already at its maximum, i.e., the liquid level cannot rise any further. However, since the cryogenic fluid is compressible, the cryogenic fluid can be “over-pressurized”, i.e., cryogenic fluid continues to be pumped into the cryogenic container 2 even though the fill level is at its maximum. In this range between the density p1 and the density p2, the pressure thus rises until the refuelling pressure pmax is reached. It should be noted at this point that this is a simplified illustration. Depending on the thermodynamic state of the inflowing cryogenic fluid, diverging courses may also arise, whereby the pressure could also drop or rise until p1 is reached.

In summary, the computing unit 13 thus receives measured values from at least two sensors for measuring a thermodynamic state of the cryogenic fluid and receives, for example, a measured pressure value and/or a measured temperature value and/or a measured density value and/or a measured liquid level value and/or a measured weight value and determines from this the hold time of the cryogenic container 2, e.g., according to the dependence in FIG. 4, the mass of cryogenic fluid and, subsequently, the hold time according to the dependence in FIG. 3. In general, the computing unit 13 determines as to whether or, respectively, when a desired thermodynamic state has been achieved in which the pressure in the cryogenic container 2 does not reach a predefined threshold value without any removal or taking into account planned removals of cryogenic fluid within a desired period of time. If the hold time decreases during refuelling, the computing unit 13 closes the valve 11 when the set desired hold time is achieved. As a result, refuelling is terminated, and the vehicle or, respectively, the cryogenic container 2 can remain stationary for a shutdown period corresponding to the desired hold time without any further removal, without cryogenic fluid being released into the environment. However, the computing unit 13 could also calculate in advance, e.g., extrapolate, when the desired thermodynamic state will be achieved during refuelling and, for example, locks the valve 11 after this time. However, if a user wants the vehicle to continue driving immediately, the aforementioned premature lock function of the valve 11 can also be deactivated in order to fill up the cryogenic container 2 at the refuelling pressure. For example, the user could choose by means of a switch as to whether the valve 11 locks or does not lock when the desired hold time is achieved. In all embodiments, setting the same hold time is herein used equivalently to setting a desired thermodynamic state.

In general, however, the computing unit 13 does not have to actuate the valve 11, but the valve 11 could also be operated manually. The computing unit 13 could still be provided, which, in this case, calculates and indicates the hold time as described above, for example, next to the filling coupling. The user can then manually lock the valve 11 at the desired hold time, whereby the same effects as described above will emerge. In another case, the computing unit 13 can be designed in a very simplified way, since, for example, the pressure and/or the height of the liquid level or, respectively, a fill level could be indicated, and the user themselves could determine the desired hold time using a slide rule and could close the valve at the given time.

Preferably, the computing unit 13 furthermore comprises a control input at which the desired hold time or, respectively, the point in time when the journey should be resumed can be set. For example, the user can individually set as to whether the vehicle should be put into operation two days or even one week after refuelling in order to individually fill up the cryogenic container 2 as much as possible without cryogenic fluid being discharged as a boil-off Due to a specific input, it is also possible for the refuelling process to be performed as it is known from the prior art, i.e., the refuelling pressure prevails in the cryogenic container 2 after the refuelling process. The user could also enter a hold time that is below the hold time which is achieved with normal refuelling, e.g., by filling the cryogenic fluid into the cryogenic container at a cooler temperature than with normal refuelling, which, however, has to be separately indicated to the filling station.

FIG. 2 shows an alternative embodiment to FIG. 1 comprising a system 17 that, if necessary, can even manage without sensors 14, 15, 15′. Due to the measurement inaccuracies of liquid level sensors and pressure sensors or, respectively, due to the cryogenic fluid sloshing during refuelling, the embodiment of FIG. 2 may be preferred. Equal reference numerals as in FIG. 1 designate equal elements in FIG. 2. For example, the system 17 of FIG. 2 also comprises a cryogenic container 2, a filling line 3, a filling coupling 4, optionally the removal line 5 with the valve 7 and/or a removal line 6 and optionally the pressure relief valve 8 with the connecting line 9. All variants explained for FIG. 1 are also usable for the embodiment of FIG. 2, unless indicated otherwise.

In this embodiment, an additional ullage tank 18 is provided which is connected to the cryogenic container 2, with a valve 19 being located between the cryogenic container 2 and the ullage tank 18, for example in an intermediate line 20 between the cryogenic container 2 and the ullage tank 18. As explained below, the valve 19 is used to set a desired hold time after refuelling so that the same effect as in the embodiment of FIG. 1 will be achieved.

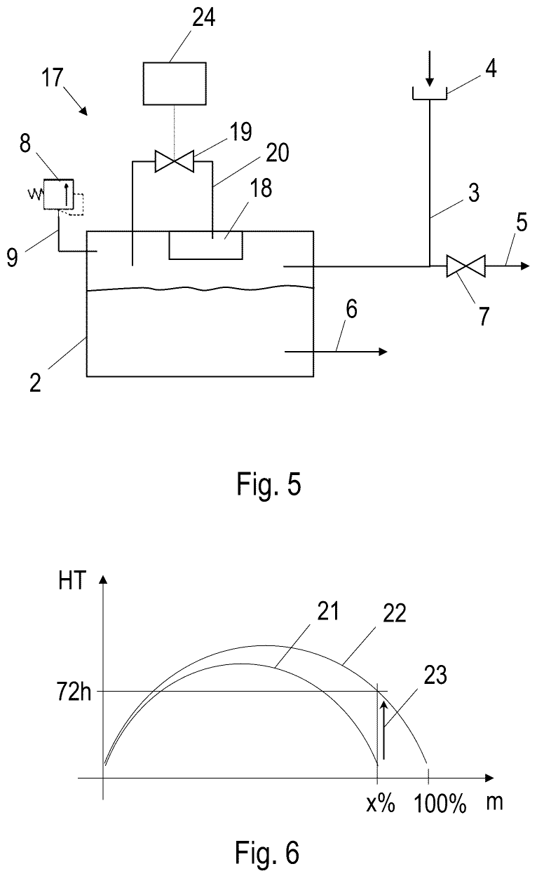

As shown in FIG. 2, the intermediate line 20 can be attached, for example, to the filling line 3 so that the ullage tank 18 is connected to the cryogenic container 2 via the intermediate line 20 and the filling line 3. As an alternative, the intermediate line 20 can run independently of the filling line 3, as shown in FIG. 5. In a further variant, the intermediate line 20 could also be omitted, and the valve 19 could connect the ullage tank 18 directly to the cryogenic container 2.

As illustrated in FIGS. 2 and 5, the ullage tank 18 is preferably located within a container forming both the cryogenic container 2 and the ullage tank 18, since, in this way, both containers can be insulated simultaneously particularly easily. A particularly simple design is provided if an intermediate wall that is essentially flat or shaped like a pressure container base is installed within a tank in order to divide the container into two parts, i.e., the cryogenic container 2 and the ullage tank 18. However, the cryogenic container 2 and the ullage tank 18 could also be located separately from each other.

In the embodiments of FIGS. 2 and 5, the refuelling of the cryogenic container 2 takes place as follows while maintaining the desired hold time. The cryogenic container 2 is filled up until the refuelling pressure prevails in the cryogenic container 2. During this refuelling, the valve 19 remains closed so that there will be no cryogenic fluid or little cryogenic fluid or only low-density cryogenic fluid in the ullage tank 18. After the refuelling process has been completed by the filling station and the cryogenic fluid at the refuelling pressure is present in the cryogenic container 2, the valve 19 is opened and cryogenic fluid flows from the cryogenic container 2 into the ullage tank 18. The mass of cryogenic fluid in the cryogenic container 2 thus decreases, and the hold time is extended.

This concept will now be explained again with reference to FIG. 6. The curve 21 shows the mass/hold time function for the cryogenic container 2 without the ullage tank 18. If only the cryogenic container 2 is filled up fully, there is a mass of x %. If the ullage tank 18 is now switched on in addition, a larger total volume results so that the mass/hold time function will change. The curve 22 illustrates the mass/hold time function for the overall system composed of the cryogenic container 2 and the ullage tank 18. Since the mass of the cryogenic fluid remains constant when switching on occurs, there is a longer hold time, in the illustrated example of three days (72 hours). The switching on of the ullage tank 18 is illustrated schematically in FIG. 6 by the arrow 23.

In the embodiment of FIGS. 2 and 5, essentially no sensors and no computing unit are necessary. After the cryogenic container 2 has been completely filled, the user can simply operate a switch in order to open the valve 19, whereby the hold time is extended. Alternatively, the valve could be designed as a pressure relief valve which activates above the refuelling pressure. The ratio of the ullage tank 18 to the cryogenic container 2 can be chosen in advance such that the predetermined desired hold time results, which can range, for example, between 24 hours and 72 hours, after the cryogenic container 2 has been filled up fully, after the valve 19 has been opened and after an equilibrium has been established between the cryogenic container 2 and the ullage tank 18.

If a computing unit 24 connected to the valve 19 is used in this embodiment, it can, for example, open the valve 19 automatically when complete refilling of the cryogenic container 2 has been determined, e.g., by closing the flap above the refuel coupling. This can be done, for example, by measuring the pressure using a pressure sensor in the cryogenic container 2 or by means of a control line which indicates that the refuel coupling 4 has been closed. Only a single sensor can also be used for this purpose, since, depending on the application, not the entire thermodynamic state needs to be determined.

In order to selectively set the hold time, the valve 19 can also be re-closed after opening so that no equilibrium is established between the cryogenic container 2 and the ullage tank 18. For example, the period of time for which the valve 19 must be open in order to bring about a certain hold time can be stored in the computing unit 24. In this case, the computing unit 24 could again have a control input for setting the desired hold time. The computing unit 24 could also be connected to the above-mentioned sensors for determining a thermodynamic state, which can be present in the cryogenic container 2 and/or in the ullage tank 18. Based on these measured values, the current hold time can be precisely determined, as described above for FIG. 1.

Furthermore, the computing unit 24 can be used for automatically detecting a start of a refuelling process, for example via a liquid level sensor or a control line on the refuel coupling 4 to indicate the connection of a fuel nozzle. After the start of the refuelling process has been detected, the valve 19 is closed so that the ullage tank 18 remains essentially empty during refuelling. Alternatively or additionally, the user can manually close the valve 19 at the start of a refuelling process.

In this embodiment, too, it may be envisaged that the function of setting the desired hold time or, respectively, the desired thermodynamic state is switched off and, instead, a function with a maximum fill quantity of cryogenic fluid or, respectively, a maximum filling pressure in the system 17 is achieved. For this purpose, the valve 19 remains open during the filling process so that, after the filling process, cryogenic fluid is present at the refuelling pressure both in the cryogenic container 2 and in the ullage tank 18.

In the embodiment of FIGS. 2 to 5, the cryogenic fluid located in the ullage tank 18 can be supplied to the consumer when the valve 19 is open, since an equilibrium will be established between these containers due to the pressure conditions and cryogenic fluid will thus flow automatically from the ullage tank 18 into the cryogenic container 2 or, respectively, via the removal line 5, 6 to the consumer.

FIG. 7 shows a system 25 in further embodiments for setting a desired hold time or, respectively, the desired thermodynamic state of the cryogenic container 2 during refuelling. Equal reference numerals as in FIGS. 1, 2 and 5 designate equal elements in FIG. 7. For example, the system 25 of FIG. 7 also comprises a cryogenic container 2, a filling line 3, a filling coupling 4, optionally the removal line 5 with the valve 7 and/or a removal line 6 and optionally the pressure relief valve 8 with the connecting line 9. All variants explained for FIGS. 1, 2 and 5 are also usable for the embodiment of FIG. 7, unless indicated otherwise.

For the system 25, a computing unit 26 is also used which determines the current mass of cryogenic fluid in the cryogenic container 2 and/or the current hold time and/or the required mass, optionally in combination with a thermodynamic state, of cryogenic fluid for achieving the desired hold time, as explained above, preferably using measuring data of a liquid level sensor 14 and/or a pressure sensor 15 and/or a temperature sensor 15′ and/or a density sensor and/or a weight sensor. In these embodiments, such data are either indicated on a display 27 by the computing unit 26 or transmitted by a transmitter 28 to the filling station 29, which can be regarded as part of the system 25 for this purpose. Alternatively, however, all parts of the system are preferably located on the vehicle, regardless of the embodiment.

When the data are indicated on the display 27, the refuelling process can be discontinued manually, for example, by the user disconnecting the fuel nozzle 30 from the refuel coupling 4 or by the user pressing a stop button 31 at the filling station 29. By activating the stop button 31, for example, a valve 32 of the filling station could be closed, which prevents further refuelling and thus ends the refuelling process.

In a specific example, the current hold time could be indicated on the display 27, for example. If the user knows, for example, that they will put the vehicle into operation within 48 hours, the user can discontinue the refuelling process if the display 27 indicates a current hold time of 48 hours. Since the current mass can be converted directly into a current hold by adding another measured variable (such as, e.g., pressure or temperature), the current mass could also be indicated to the user, wherein a measured pressure value can optionally also be seen on the display 27 in order to determine the hold time more precisely. Optionally, one or several tables for converting the mass into the hold time can be visible next to or, respectively, in the area of the display 27.

In another example, the user could enter the desired hold time into the computing unit 26, e.g., via an interface in the computing unit 26, and the computing unit could determine the required mass of cryogenic fluid, optionally in combination with a required thermodynamic state (e.g., 100 kg cryogenic fluid at 6 bar), for achieving the desired hold time and could indicate it on the display 27. The user could enter this indicated required mass, optionally in combination with the required thermodynamic state, into an interface of the filling station 29, which discontinues the refuelling process as soon as the required mass has been transferred into the cryogenic container 2 via the filling coupling 4. In the simplest case, the filling station 29 dispenses cryogenic fluid at a temperature essentially corresponding to the temperature of the cryogenic fluid in the cryogenic container 2. If the temperatures are different, this could be taken into account when providing the mass in order to achieve the desired hold time.

In analogy to the display 27, the computing unit 26 could also transmit said data directly to the filling station 29, for which purpose the transmitter 28 connected to the computing unit 26 on the vehicle can communicate with a receiver 33 of the filling station 29. The transmitter 28 and the receiver 33 could each also be designed as a transceiver for bidirectional communication. The filling station 29 can, in turn, display the received data, whereupon the user can manually discontinue the refuelling process. The filling station could terminate the refuelling process also automatically, for example when the user enters the desired hold time into an interface of the filling station 29 or as soon as the filling station 29 has transferred the required mass of cryogenic fluid into the cryogenic container 2 via the filling coupling 4.

In all aforementioned embodiments, it may be relevant that the filling station 29 provides cryogenic fluid at a temperature which is different from the temperature of the cryogenic fluid in the cryogenic container. This can be relevant because the cryogenic fluid introduced into the cryogenic container can, for example, also reduce the pressure and thus influence the calculation of the hold time. Thus, it can optionally be envisaged that the temperature of the cryogenic fluid provided by the filling station or, respectively, the temperature of the cryogenic fluid located in the cryogenic container is taken into account when determining the required mass for the desired hold time. This can be achieved, for example, by data transmission from the filling station 29 to the computing unit 13, 24, 26, or vice versa.

In summary, the various embodiments of FIGS. 1, 2, 5 and 7 are linked in that they each comprise means for setting the desired hold time of the cryogenic container, with setting taking place during or after refuelling. In the embodiment of FIG. 1, such means are formed by the valve 11 and optionally by a display or, respectively, a control device 13. In the embodiment of FIGS. 2 and 5, such means are formed by the ullage tank 18 and the valve 19 and optionally by a display or, respectively, a control device 24. In the embodiment of FIG. 7, the means are formed by the control device 26 and the display 27 or, respectively, the transmitter 28, optionally also by the filling station 29 and its components 30, 31, 32, 33.

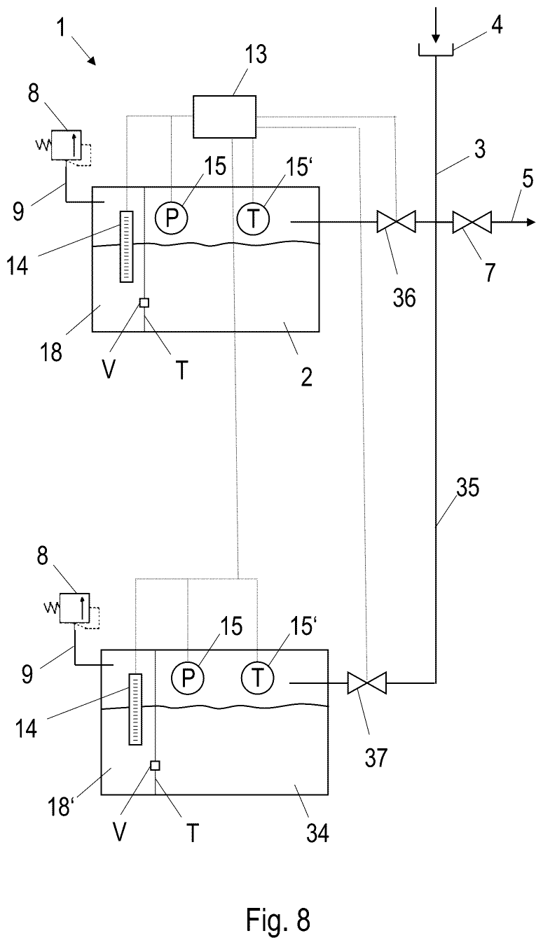

FIG. 8 shows an embodiment in which a further cryogenic container 34 is mounted on the vehicle, with the further cryogenic container 34 also being fillable via the above-mentioned ancillary system. For this purpose, a further filling line 35 is routed into the further cryogenic container 34 and connected to the first-mentioned filling line 3. In this way, both cryogenic containers 2, 34 can be filled simultaneously via a common filling coupling 4. This is known per se from the prior art and, as a rule, refuelling is done via the filling coupling 4 until the filling pressure is applied in both cryogenic containers 2, 34, i.e., until both cryogenic containers 2, 34 have been filled up completely.

In this system, the cryogenic containers 2, 34 could basically also have a different hold time, e.g., if the cryogenic containers 2, 34 are designed in different sizes and/or a different amount of cryogenic fluid is present in the two cryogenic containers 2, 34, for example because of a differing removal. According to the invention, a valve 36 is now provided in the filling line 3 and a further valve 37 is provided in the further filling line 35, with the valves 36, 37 being actuated depending on the respective desired hold time. In particular, the valves 36, 37 can be actuated in such a way that both cryogenic containers 2, 34 have the same current hold time, preferably at any time during refuelling (so that, in each case, the same hold time exists after a sudden discontinuation of refuelling). The valves could also be actuated in such a way that they each have the same desired hold time after a refuelling process. In order to achieve this control, both cryogenic containers 2, 34 could have a common computing unit or, in each case, separate computing units, which can determine the thermodynamic properties or, respectively, the mass and, therefrom, the hold time of the respective cryogenic containers.

This embodiment with two cryogenic containers 2, 34 can be combined with all aforementioned embodiments so that it is possible, in particular, to adjust that both cryogenic containers 2, 34 will have the same desired hold time after refuelling. In this case, the valves can perform a dual function, especially if they are actuated like the valve 11 of FIG. 1. As an example, however, this embodiment with two cryogenic containers 2, 34 could also be combined with the embodiment in which the filling station provides a desired mass of cryogenic fluid at the filling coupling 4. In this case, the valves 35, 36 partition this mass so that the desired hold time is subsequently present in both cryogenic containers 2, 34. Both cryogenic containers 2, 34 could also have their own or a common ullage tank 18. Two separate displays 27 could also be provided, each of them indicating the current hold time of the two cryogenic containers 2, 34. When data are transmitted to the filling station 29, the data of the two cryogenic containers 2, 34 can be transmitted separately or after having been linked, e.g., a required total mass could be requested.

If two cryogenic containers 2, 34 are filled up via the same filling coupling 4, but no computing unit or, respectively, two valves is/are provided for setting the same hold time, an essentially equal hold time will nevertheless be established between the two cryogenic containers after a certain period of time, since the cryogenic fluid will be distributed substantially equally between the two cryogenic containers.

The system described with reference to FIG. 8 can also be expanded to more than two cryogenic containers 2, 34.

Finally, it should be noted that, with the present invention, it is also possible to fill up the cryogenic container 2 with cryogenic fluid at such a low temperature and/or such a low pressure that an immediate continuation of the journey is not possible. The temperature can be chosen such that the cryogenic fluid heats up during the shutdown period to such an extent that, after the shutdown period, it will have a temperature that is suitable for the vehicle to continue its travel. As a result, it becomes possible that, compared to normal refuelling, the same amount of cryogenic fluid is fillable into the cryogenic container 2, whereby the thermodynamic state of the cryogenic fluid after the shutdown period essentially corresponds to that one existing immediately after refuelling in case of normal refuelling, or just corresponds to the state in which the pressure is achieved in particular at the end of the shutdown period in order to be able to put the vehicle into operation. The stored mass can thereby be increased even compared to the mass present at refuelling pressure.

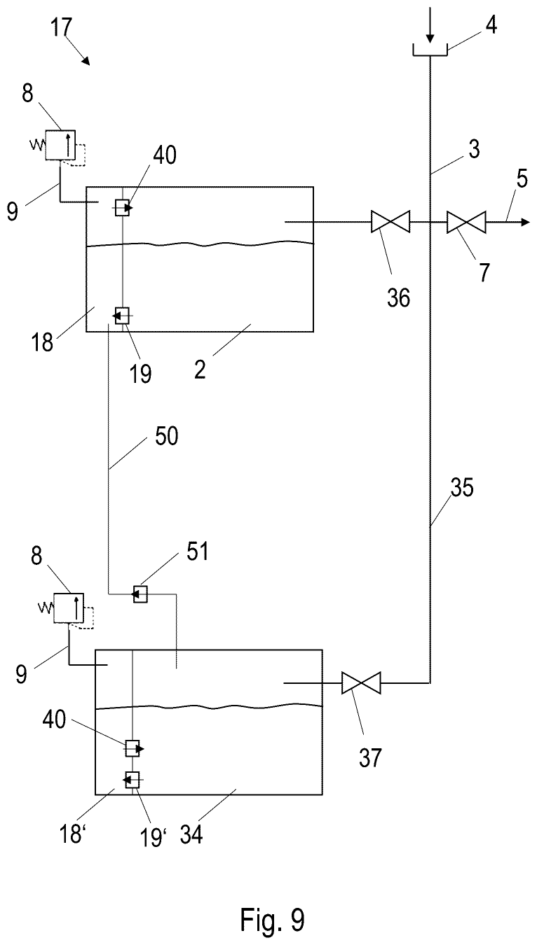

FIG. 9 shows an embodiment analogous to FIG. 8 and comprising two cryogenic containers 2, 34, each having their own ullage tank 18, 18′. The first cryogenic container 2 and the first ullage tank 18 can be surrounded by a common insulating outer shell, and the second cryogenic container 34 and the second ullage tank 18′ can be surrounded by a common insulating outer shell. The first cryogenic container 2 is connected to its ullage tank 18 via a first valve 19, and the second cryogenic container 34 is connected to its ullage tank 18′ via a second valve 19′. The refuelling line can be implemented as explained for FIG. 8. After both cryogenic containers 2, 34 have been filled up completely, the valves 19, 19′ can be opened so that the hold time can be extended in both cryogenic containers 18, 18′. Alternatively, only a single ullage tank 18 could be also provided (i.e., the further ullage tank 18′ can be omitted), and a connecting line 50 connects the second cryogenic container 34 to the ullage tank 18. By opening a valve 51 (which, in turn, could be designed as a pressure relief valve opening towards the ullage tank 18) in the connecting line 50, the hold time of both cryogenic containers 2, 34 can be extended. The valves 19, 19′ and, respectively, 19, 51 can each be coupled so that they are opened and closed simultaneously. All measures explained for the embodiments of FIGS. 1 to 8 can be implemented also in this case.

However, since the connecting line 50 is disadvantageous because of the additional points of connection to the cryogenic containers, it may be envisaged that the transfer of cryogenic fluid from the second cryogenic container 34 into the ullage tank 18 of the first cryogenic container 2 is effected in that the valves 36, 37 in the filling line 3 or, respectively, in the further filling line 35 are opened after refuelling.

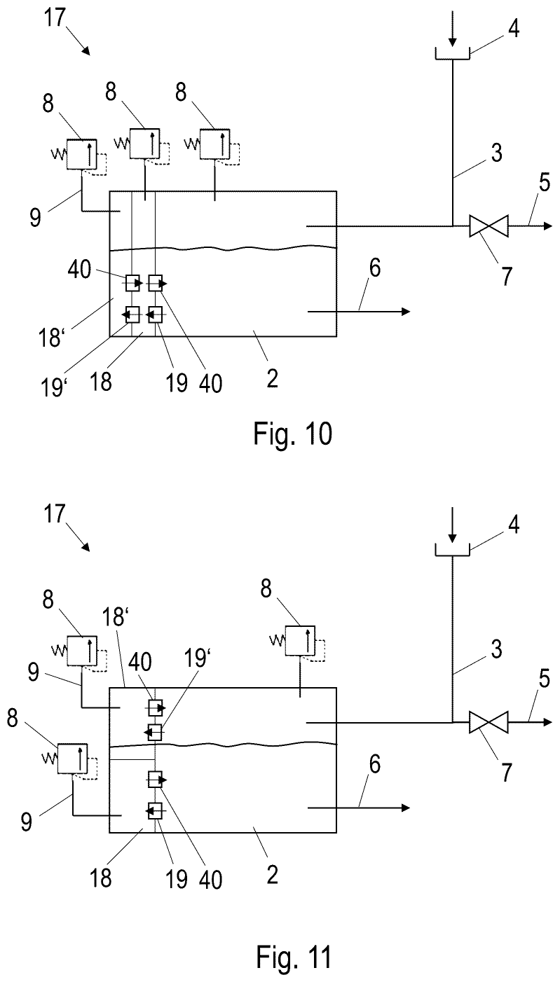

FIG. 10 shows an embodiment in which two ullage tanks 18, 18′ are used. The first ullage tank 18 is located between the cryogenic container 2 and the second ullage tank 18′ so that the second ullage tank is fillable only via the first ullage tank 18. This is therefore a cascade-like placement of ullage tanks 18, 18′. It will be understood that more than two ullage tanks 18 could also be provided in the same way. For this purpose, the cryogenic container 2 is connected to the first ullage tank 18 via a first valve 19, and the first ullage tank 18 is connected to the second ullage tank 18′ via a second valve 19′.

FIG. 11 shows an alternative embodiment with two ullage tanks 18, 18′, which are connected to the cryogenic container 2 not in a cascade-like manner, but rather in parallel to each other, i.e., the cryogenic container 2 is connected to the respective ullage tank 18, 18′ via its own valve 19, 19′.

The valves 19, 19′ can be actuatable manually or via the computing unit 24. Alternatively or additionally, they can be designed as pressure relief valves opening in the direction of the ullage tanks, and check valves 40 could be provided to enable cryogenic fluid to be removed from the ullage tanks 18, 18′. The pressure relief valves preferably open at a transfer pressure of, e.g., 18 bar, which is above the refuelling pressure (e.g., 16 bar). Outward-opening pressure relief valves 8 are preferably attached both to the cryogenic container 2 and to all ullage tanks (even if there is only one). The pressure relief valves can open at the same or at a higher pressure than the valves 19, 19′, if the latter are designed as pressure relief valves.

In the embodiments of FIGS. 10 and 11, each ullage tank corresponds to a certain additional hold time. For example, if both valves 19, 19′ are closed during refuelling, a first hold time of, e.g., 24 hours can be achieved after the valves 19, 19′ have been opened after refuelling. However, the first one of the valves 19 could also be opened during refuelling so that a shorter hold time of, e.g., 12 hours can be set. It is evident that, by providing several ullage tanks 19, 19′, further options for individually setting the hold time are created. Coming back to the upper cryogenic container 2 with the ullage tank 18 in FIG. 9, another option is explained at this point as to how the hold time could be set using the cryogenic container 2. Instead of the illustrated valves 19, 40, two permanent openings could also be provided, with one opening being located at the lower end of the dividing wall T so that liquid cryogenic fluid can flow into the ullage tank 18, and one opening being located at the upper end to enable pressure equalization in the gas phase. When this system is refuelled, the cryogenic container 2 is first filled up until it is filled to maximum capacity. However, a low fill level will continue to be present in the ullage tank 18, as the openings limit the flow. However, the pressure will be essentially the same in both containers, because the opening arranged at the upper end of the dividing wall enables said pressure equalization in the gas phase. However, refuelling could continue after the end of standard refuelling, whereby liquid cryogenic fluid flows into the ullage tank 18 via the lower opening, causing the ullage tank 18 also to be filled over time. Precise setting of the hold time can be achieved if, for example, a flow rate sensor is arranged in the lower opening, by means of which it can be determined as to how much cryogenic fluid is present in the ullage tank 18. Alternatively, the upper opening could even be omitted, and a pressure sensor in the ullage tank 18 and a pressure sensor in the cryogenic container 2 are provided. Since the upper opening is omitted, there will be no pressure equalization. After the end of standard refuelling, refuelling can be continued also in this case in order to continue the slow filling of the ullage tank 18. The amount of cryogenic fluid in the ullage tank 18 is thereby provided by the pressure difference between the cryogenic container 2 and the ullage tank 18 so that the current hold time can be inferred unambiguously.

Finally, it should be emphasized that all aforementioned embodiments can be combined. In particular, for example, the embodiment of FIG. 1 can be combined with the embodiment of FIG. 2 so that the user is enabled to choose as to whether the hold time is set, for example, by closing the valve 11 or by opening the valve 19 after refuelling or by sending data to a filling station.

1-19. (canceled)

20. A system comprising:
a vehicle;
a cryogenic container mounted on the vehicle;
an ancillary system for filling the cryogenic container with cryogenic fluid, wherein the ancillary system comprises:
a filling line routed into the cryogenic container; and
a filling coupling, wherein the cryogenic container is fillable via the filling line;
the system further comprising:
a ullage tank; and
at least one sensor in communication with the ullage tank in order to determine a thermodynamic state of the cryogenic fluid during a refuelling process
a computing unit designed for determining whether the thermodynamic state of the cryogenic fluid in the cryogenic container corresponds to a desired state in which the pressure in the cryogenic container does not reach a predefined threshold value without any removal or taking into account planned removals of cryogenic fluid within a desired period of time, and/or
wherein the computing unit is designed for determining data to determine whether further addition of the cryogenic fluid, starting from the thermodynamic state determined by the sensor, achieved the desired state, and
wherein the system furthermore comprises means for terminating the refuelling process and/or displaying said data for terminating the refuelling process or for transmitting said data to a filling station;
and/or
the system further comprising means for transferring the cryogenic fluid from the cryogenic container into the ullage tank after the refuelling process, in order to bring the cryogenic fluid in the cryogenic container into a state in which the pressure in the cryogenic container does not reach a predefined threshold value without any removal or taking into account planned removals of the cryogenic fluid within a desired period of time.

21. The system according to claim 20, wherein the means for terminating comprise a valve arranged directly in the filling line for terminating the refuelling process.

22. The system according to claim 20, further comprising a valve arranged between the ullage tank and the cryogenic container for transferring the cryogenic fluid into the ullage tank, wherein the valve is configured to be actuated manually or via a computing unit, wherein the valve is a pressure relief valve that opens in a direction of the ullage tank when a transfer pressure above a refuelling pressure is present in the cryogenic container.

23. The system according to claim 21, wherein the valve arranged directly in the filling line or a valve arranged between the ullage tank and the cryogenic container can be brought into an alternative operating state in which the cryogenic container and/or the ullage tank are fillable according to a standard refuelling process.

24. The system according to claim 22, wherein the cryogenic container and the ullage tank are surrounded by a common insulating outer shell, wherein the valve arranged between the ullage tank and the cryogenic container is located within the common insulating outer shell.

25. The system according to claim 22, wherein a volume of the ullage tank is chosen in relation to a volume of the cryogenic container such that a desired thermodynamic state of the cryogenic fluid is attained after a pressure equilibrium has been established between the ullage tank and the cryogenic container with the valve between the ullage tank and the cryogenic container, after complete filling with the valve closed, with the desired period of time equating to at least 12 hours, 16 hours, 24 hours, 72 hours, 144 hours or 230 hours.

26. The system according to claim 22, further comprising at least one further ullage tank and at least one further valve provided between the cryogenic container and the at least one further ullage tank or between the ullage tank and the at least one further ullage tank, wherein the at least one further valve can be opened individually to selectively set a hold time after a refuelling process.

27. The system according to claim 20, wherein, between the ullage tank and the cryogenic container, a permanent opening is provided, a cross-sectional area of which does not exceed 100 mm², or does not exceed 75 mm², and/or ranges between 2 mm² and 4 mm² and/or wherein the cross-sectional area of the opening (V) is at most 25%, at most 10%, at most 5% or at most 2% of the cross-sectional area of the filling line.

28. The system according to claim 20, wherein the sensor connected to the ullage tank comprises a fill level sensor, pressure sensor, temperature sensor projecting into the ullage tank or an optical sensor for measuring a transparency of the cryogenic fluid and/or wherein the sensor connected to the ullage tank is located between the ullage tank and the cryogenic container.

29. The system according to claim 22, wherein the computing unit is connected to the valve between the ullage tank and the cryogenic container and configured to directly actuate the valve between the ullage tank and the cryogenic container, in order to bring the cryogenic fluid in the cryogenic container into a state in which the pressure in the cryogenic container does not reach a predefined threshold value without any removal or taking into account planned removals of cryogenic fluid within the desired period of time.

30. The system according to claim 20, further comprising a display, wherein the computing unit is configured for indicating on the display a current period of time until the predefined threshold value is reached or that the desired state has been achieved.

31. The system according to claim 20, wherein the means for terminating comprises a transmitter for transmitting data to a filling station, wherein the computing unit is configured for determining a mass required for achieving the desired state, in combination with a required pressure and/or a required temperature, and/or a current period of time until the predefined threshold value is reached and/or a current mass of the cryogenic fluid in the cryogenic container, in combination with a current pressure in the cryogenic container and/or a current temperature in the cryogenic container, or an indication that the desired state has been achieved and for transmitting to the filling station.

32. The system according to claim 20, further comprising a further cryogenic container, wherein a further filling line is connected to the filling line and routed into the further cryogenic container so that both the cryogenic container and the further cryogenic container can be filled up via the filling coupling, with the cryogenic container and the further cryogenic container being connected to their own ullage tank.

33. The system according to claim 20, further comprising a journey planning unit in which at least one next route to be driven is stored or can be determined, wherein a time of the start of the journey for this route is stored or can be determined, and the journey planning unit is configured for selecting a desired period of time and a required mass of cryogenic fluid for a given thermodynamic state so that the cryogenic fluid is maximized or will at least be sufficient for reaching a next filling station on the route, and so that the pressure in the cryogenic container is not reached until the time of the start of the journey or is reached only for a shortest possible time.

34. The system according to claim 20, wherein the filling station comprises a receiver for receiving the data transmitted by said transmitter, the filling station being designed for terminating a refuelling process depending on the data received or, respectively, for providing cryogenic fluid with a required mass, temperature and pressure in order to establish the thermodynamic state in the cryogenic container.

35. A method of refuelling the system according to claim 21, comprising the steps of:
opening the valve arranged in the filling line;
filling up the cryogenic container via the refuel coupling;
closing said valve when the desired thermodynamic state in the cryogenic container has been achieved.

36. The method of refuelling the system according to claim 22, comprising the steps of:
closing the valve arranged between the cryogenic container and the ullage tank;
filling up the cryogenic container via the refuel coupling according to standard refuelling and optionally detecting the end of standard refuelling;
opening said valve.

37. The method of refuelling the system according to claim 30, comprising the steps of:
filling up the cryogenic container via the refuel coupling,
indicating at least one of said data on the display,
manually terminating the refuelling process when the desired thermodynamic state in the cryogenic container has been achieved.

38. The method of refuelling the system according to claim 33, comprising the steps of:
filling up the cryogenic container via the refuel coupling,
transmitting at least one of said data to the filling station,
terminating the refuelling process by the filling station when the desired thermodynamic state in the cryogenic container has been achieved.

39. The system of claim 20, wherein the cryogenic container comprises a hydrogen container or an sLH2 container.
